(19) United States
(12) Patent Application Publication
(10) Pub. No.: US 2013/0215202 A1
(43) Pub. Date: Aug. 22, 2013

(54) HELICAL DRYER PATH FOR A PRINT SUBSTRATE WEB

(71) Applicants: Kevin David Koller, San Diego, CA (US); Thomas J. Tarnacki, San Diego, CA (US)

(72) Inventors: Kevin David Koller, San Diego, CA (US); Thomas J. Tarnacki, San Diego, CA (US)

(21) Appl. No.: 13/401,899

(22) Filed: Feb. 22, 2012

(51) Int. Cl. B41J 2/01

(52) U.S. Cl. 347/102

(57) ABSTRACT

In one example, a print substrate web path through a printer includes a first web path through a printing unit and a helical second web path through a dryer.

### BACKGROUND

In some high speed inkjet web printers, the first side of the web is printed at a first printing unit, the web is inverted, and then the second side of the web is printed at a second printing unit. The web is guided through a dryer after each side is printed to dry the ink enough to allow the web to move through the rest of the printer without damaging the printed images.

### DRAWINGS

FIG. 1 is a block diagram illustrating one embodiment of a web printer in which examples of a new, helical dryer path for a print substrate web may be implemented.

FIG. 2 is an elevation view illustrating one example of a helical dryer path for a print substrate web in a printer such as the web printer shown in FIG. 1.

FIGS. 3, 4, and 5 are plan view sections illustrating example configurations for the helical dryer path shown in FIG. 2.

FIGS. 6 and 7 are perspective and elevation views, respectively, illustrating one example of a helical dryer web path in a single station, arched inkjet web printer.

FIG. 8 illustrates one example of a helical dryer web path in a two station, arched inkjet web printer.

The same part numbers designate the same or similar parts throughout the figures.

### DESCRIPTION

A helical dryer path for a print substrate web has been developed to help increase drying capacity in high speed inkjet web printers without also significantly increasing the footprint or height of the printer. Thus, examples of the new web path are described below with reference to an inkjet web printer dispensing ink as the imaging material. The new dryer web path, however, is not limited to inkjet printers or printing with ink and nothing in the following description should be construed to limit the scope of the invention, which is defined in the claims that follow this description.

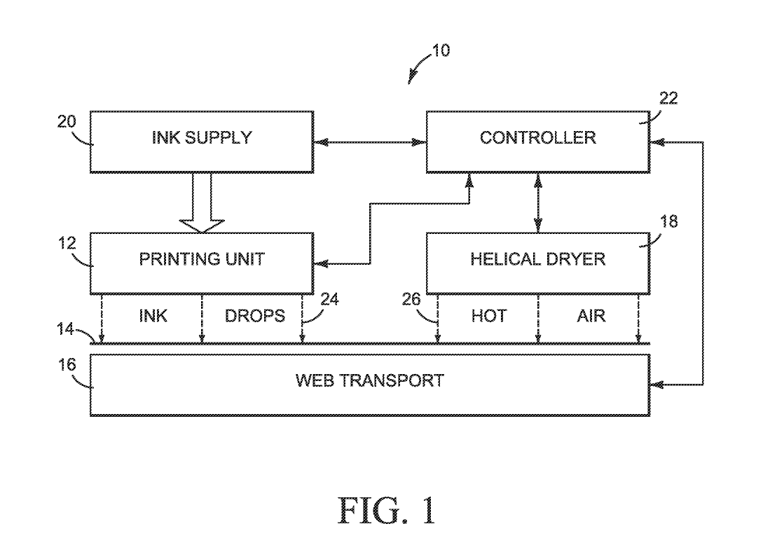

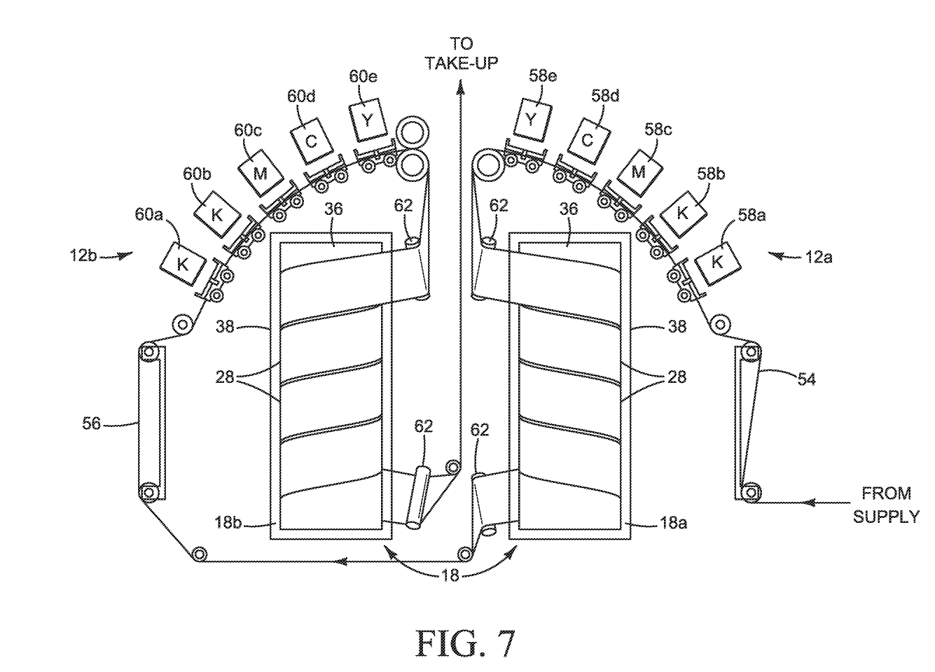

FIG. 1 is a block diagram illustrating an inkjet printer 10 that includes a printing unit 12, a print substrate web 14, a web transport mechanism 16, a dryer 18, an ink supply 20, and a controller 22. Printing unit 12 represents generally an inkjet printing device for applying ink to print substrate 14 as it moves through a print zone near unit 12 at the urging of transport mechanism 16. Controller 22 represents generally the programming, processors and associated memories, and the electronic circuitry and components needed to control the operative elements of printer 10. Due to the massive amount of data and signal processing needed for a large, high speed inkjet web printer, controller 22 may include, for example, servers and computer work stations as well as central processing units and associated memories (RAM and hard drives for example), and application specific integrated circuits. As described in more detail below with reference to FIGS. 6 and 7, printing unit 12 may include a series of print bars arranged in an arch with each print bar containing, for example, an array of ink pens each carrying one or more printhead dies and the associated mechanical and electrical components for dispensing ink drops 24 on to web 14. Also, as described in more detail below, web 14 is guided along a helical path through dryer 18 where web 14 is exposed to hot air 26 or another suitable drying agent to dry the ink or other imaging material on web 14.

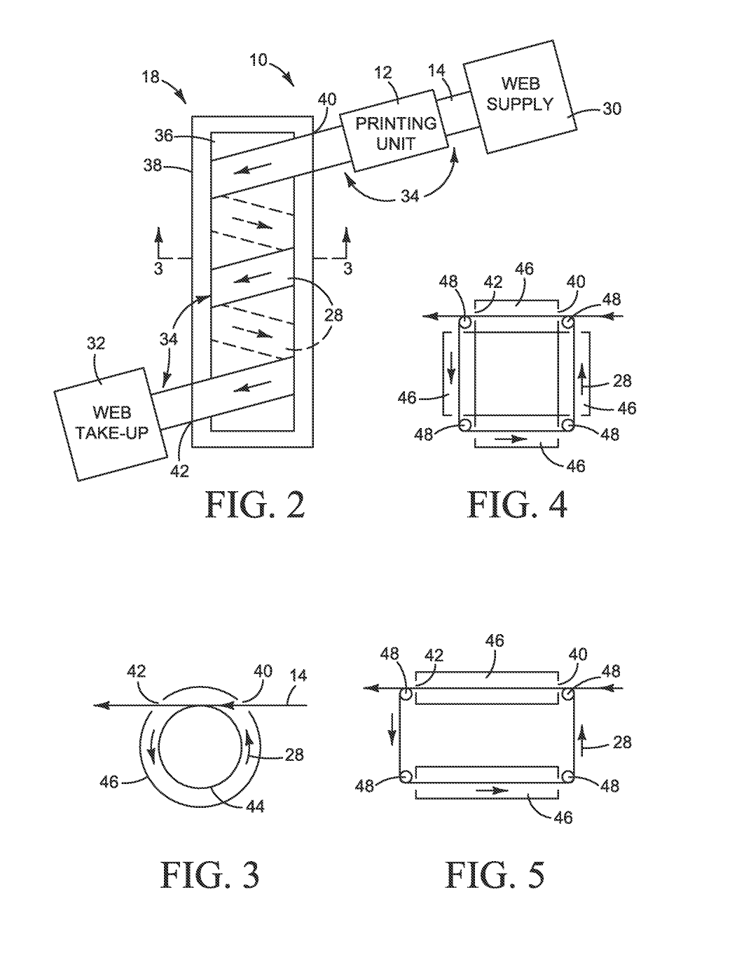

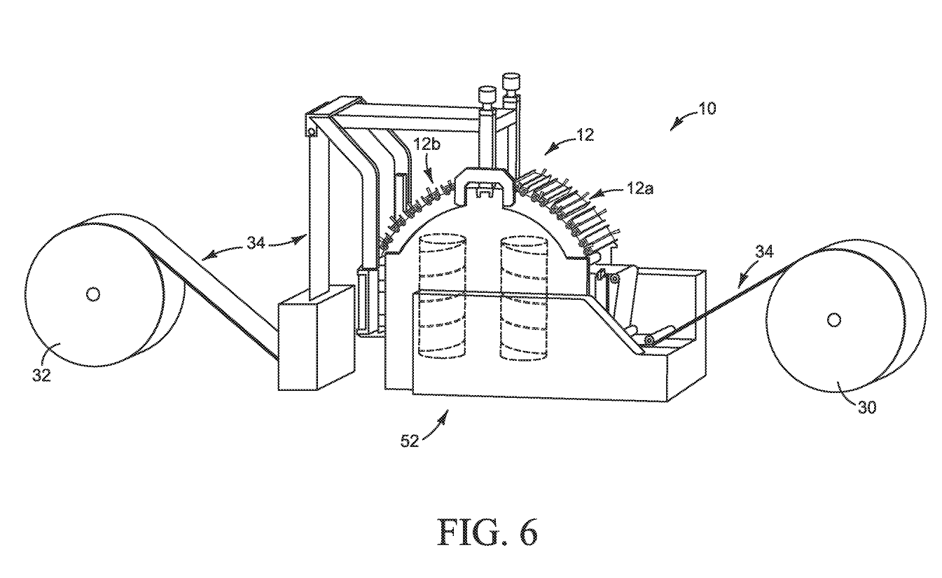

FIG. 2 is an elevation view illustrating one example of a helical dryer path 28 for a print substrate web 14 in a printer 10 such as the web printer shown in FIG. 1. FIGS. 3, 4, and 5 are plan view sections illustrating example configurations for helical path 28 shown in FIG. 2. Referring to FIG. 2, printer 10 includes a web supply 30, printing unit 12, dryer 18, and a web take-up 32. A web path 34 extends from web supply 30 through printing unit 12 and dryer 18 to web take-up 32. The helical part of web path 34 through dryer 18 is designated by part number 28. Dryer 18 includes a web support 36 and a drying element 38. Web 14 travels around and down support 36 in dryer 18 from an inlet 40 to an outlet 42. Web 14 may be fed into dryer inlet 40 at an angle, as shown in FIG. 2, such that web 14 spirals down support 36 without wrapping back over itself. Alternatively, web 14 may be turned to the desired feed angle inside dryer 18.

In the example shown in FIG. 3, support 36 is implemented as a cylindrical drum 44 and drying element 38 is implemented as a hot air enclosure 46. Drum 44 is surrounded by enclosure 46 through which hot air may be circulated over web 14 as it spirals down drum 44. Air holes and/or pushers in the surface of drum 44 may be used to help move web 14 down the length of drum 44. A forced hot air enclosure is just one example of a suitable drying agent. Other suitable drying agents are possible. For example, hot air might be introduced into dryer 18 through perforations in drum 44 such that web 14 floats along drum 44 on a cushion of hot air, or the drying agent may include a heated drum 44, an ultrasonic vibrating drum 44, and/or an ultraviolet lighting enclosure 46.

In the example shown in FIG. 4, support 36 is implemented as a series of rollers 48 arranged in a square (which is a specific kind of rectangle). Drying element 38 is implemented as a corresponding series of hot air enclosures 46 extending down along each side of the square. Alternatively, a single hot air enclosure surrounding rollers 48 could be used. Again, other suitable drying agents are possible. While it is expected that rollers 48 will usually be non-driven rollers that passively guide web 14 down through dryer 18 (e.g., idler rollers), one or more rollers 48 could be driven rollers that help to move web 14 through dryer 18.

In the example shown in FIG. 5, support 36 is implemented as a series of rollers 48 arranged in a rectangle in which the width is considerably smaller than the length. Drying element 38 is implemented as a pair of hot air enclosures 46 each extending down along a long side of the rectangle. In this example, web 14 spirals down the rectangular rollers along a helical path 28 that carries web 14 back and forth in and out of enclosures 46.

FIG. 6 is a perspective view illustrating one example of a helical dryer web path 28 implemented in a single station inkjet web printer 10. FIG. 7 is an elevation view illustrating dryer web path 28 in more detail. Referring to FIG. 6, printer 10 includes a web supply spool 30 from which web 14 is fed to a printing station 52 and a take-up spool 32 onto which web 14 is wound after passing through printing station 52. Referring now also to FIG. 7, printing station 52 includes an arched printing unit 12 and a dryer 18 positioned under and contained within the footprint of arched printing unit 12. Arched printing unit 12 includes a first printing unit 12a for printing on a first side 54 of web 14 and a second printing unit 12b for printing on a second side 56 of web 14. First printing unit 12a includes a first series of print bars 58a-58e arranged along an arc on one side of arched printing unit 12. Second printing unit 12b includes a second series of print bars 60a-60e arranged along an arc on the other side of arched printing unit 12. In one example arrangement, shown in FIG. 7, print bars 58a, 58b, 60a and 60b dispense black (K) ink, print bars 58c and 60c dispense magenta (M) ink, print bars 58d and 60d dispense cyan (C) ink, and print bars 58e and 60e dispense yellow (Y) ink.

Referring to FIG. 7, dryer 18 includes a first dryer 18a for drying web first side 54 and a second dryer 18b for drying web second side 56. Dryers 18a and 18b may be housed together within a single dryer unit or separately. Each dryer 18a, 18b includes a web support 36 and a drying element 38. As noted above with reference to FIGS. 2-5, any suitable drying element 38 may be used. Turn rollers 62 may be used to guide web 14 at the desired angle into and out of each dryer 18a, 18b.

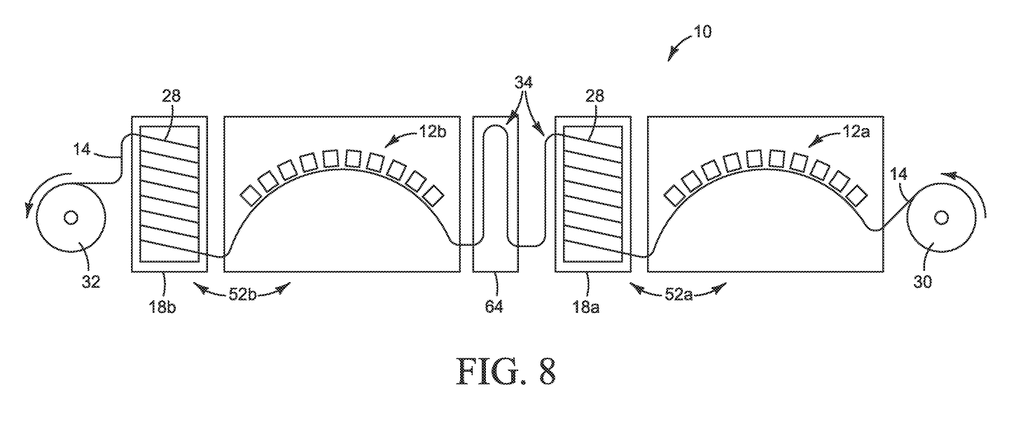

FIG. 8 illustrates one example of a helical dryer web path 28 implemented in a two station inkjet web printer 10. Referring to FIG. 8, printer 10 includes a first printing station 52a for printing and drying the first side of web 14 and a second printing station 52b for printing and drying the second side of web 14. Web path 34 extends from a web supply 30 to first printing station 52a, around a turn bar 64, to second printing station 52b, and then to web take-up 32. Each printing station 52a, 52b includes an arched printing unit 12a, 12b and a dryer 18a, 18b implementing a helical web path 28.

A helical dryer web path such as that shown in the figures and described above lengthens the web path through the dryer to help increase drying capacity. While inkjet web printers are shown, examples of the new dryer web path can be implemented in other types of web printers or other web processing devices. Also, although vertically oriented helical dryer web paths are shown, other orientations are possible. Horizontally oriented helical dryer paths, for example, may be desirable for some printing implementations.

As noted at the beginning of this Description, the examples shown in the figures and described above illustrate but do not limit the invention. Other examples may be made and implemented. Therefore, the foregoing description should not be construed to limit the scope of the invention, which is defined in the following claims.

What is claimed is:

1. A print substrate web path through a printer, the web path comprising:
a first web path through a printing unit; and
a helical second web path through a dryer, the helical second web path downstream from and connected to the first web path.

2. The web path of claim 1, wherein:
the first web path comprises a first web path through a first printing unit for printing on a first side of the web;
the helical second web path comprises a helical second web path through a first dryer for drying the first side of the web; and
the web path further comprises:
a third web path through a second printing unit downstream from the first dryer for printing on a second side of the web; and
a helical fourth web path through a second dryer downstream from the second printing unit for drying the second side of the web.

3. The web path of claim 2, wherein:
the first and third web paths together form an arch along which imaging material may be applied to the web by the first and second printing units; and
the helical second and fourth web paths lie within a footprint of the arch.

4. A printer, comprising:
a printing unit for applying an imaging material to a print substrate web; and
a dryer downstream from the printing unit to dry imaging material on the web, the dryer including a support to support the web along a helical path through the dryer.

5. The printer of claim 4, wherein the support comprises a drum, the web wrapping the drum as the web moves along the helical path.

6. The printer of claim 4, wherein the support comprises multiple rollers arranged in a rectangle such that the web forms a rectangular perimeter around the rollers as the web moves along the helical path.

7. The printer of claim 4, wherein the dryer also includes an enclosure surrounding at least part of the helical path to channel air past the web.

8. The printer of claim 4, wherein:
the support comprises a drum, the web wrapping the drum as the web moves along the helical path; and
the dryer also includes an enclosure surrounding the drum to channel hot air past the web.

9. The printer of claim 4, wherein:
the support comprises multiple rollers arranged in a rectangle such that the web forms a rectangular perimeter around the rollers as the web moves along the helical path; and
the dryer also includes an enclosure extending along two or more sides of the rectangle enclosing at least part of the helical path to channel air past the web.

10. The printer of claim 9, wherein the enclosure comprises multiple enclosures each extending along one side of the rectangle.

11. An inkjet printer, comprising:
a supply to supply a print substrate web;
an arched printing unit including multiple inkjet print bars arranged along an arc for applying ink to a print substrate web from the supply; and
a dryer including a first part to support the web along a first helical path and a second part to dry the web from the printing unit as the web moves along the first helical path.

12. The printer of claim 11, wherein:
the arched printing unit comprises:
a first arched printing unit including first print bars arranged along an arc for applying ink to a first side of the web from the supply; and
a second arched printing unit including second print bars arranged along an arc for applying ink to a second side of the web; and
the dryer comprises:
a first dryer including a first part to support the web along a first helical path and a second part to dry the web from the first printing unit as the web moves along the first helical path; and
a second dryer including a first part to support the web along a second helical path and a second part to dry the web from the second printing unit as the web moves along the second helical path.

13. The printer of claim 11, wherein:
the multiple print bars comprise:
first print bars arranged along an arc on a first side of the printing unit for applying ink to a first side of the web from the supply; and
second print bars arranged along an arc on a second side of the printing unit for applying ink to a second of the web;
the dryer comprises:
a first dryer including a first part to support the web along a first helical path and a second part to dry the web from the first print bars as the web moves along the first helical path; and
a second dryer including a first part to support the web along a second helical path and a second part to dry the web from the second print bars as the web moves along the second helical path; and
the first and second dryers are positioned within a footprint of the arched printing unit.
